(19) United States
(12) Patent Application Publication
(10) Pub. No.: US 2011/0040417 A1
(43) Pub. Date: Feb. 17, 2011

(54) Task Scheduling Based on Financial Impact

(76) Inventors: Andrew Wolfe, Los Gatos, CA (US); Thomas M. Conte, Atlanta, GA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/540,392

(22) Filed: Aug. 13, 2009

(51) Int. Cl. G06F 9/46; G06Q 10/00; G06Q 50/00; G06F 17/30; G06F 1/26

(52) U.S. Cl. 700/291; 705/8; 718/104; 707/E17.005

(57) ABSTRACT

Times at which certain tasks are performed by a computer system, such as a data storage center, may be selected to reduce the cost of electrical energy in running the tasks. Tasks may be performed when the cost of electrical energy is relatively low. Alternatively, or in addition, tasks may be performed when there is a reduced call for air conditioning to cool the electronics of the computer system.

### BACKGROUND

A data storage center may include a piece or collection of electronic hardware that stores data in one or more memory devices for later retrieval. For example, a storage area network (SAN) may include one or more data storage centers. Data storage centers have tasks or activities that need to run constantly, but such centers also have tasks that need to run only once in awhile. Examples of such tasks that may be performed on an irregular basis include data backup, indexing, media encoding, and data mining. However, data backup may be performed on a regular basis in some cases.

The tasks performed by data storage centers may involve high levels of data processing, and hence may consume a great deal of electrical power and produce a great deal of heat. Data storage centers may operate better when kept at a relatively cool temperature. Thus, additional electrical power may be consumed in keeping data storage centers cool via air conditioning, particularly when they are performing tasks.

### BRIEF DESCRIPTION OF THE SEVERAL VIEWS OF THE DRAWING

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a block diagram of an example data storage arrangement;

FIG. 2 is a flowchart showing the operation of an example task scheduling method for a data storage center;

FIG. 3 is a block diagram of another example data storage arrangement;

FIG. 4 is a flowchart showing the operation of another example task scheduling method for a data storage center; and

FIG. 5 is a block diagram illustrating an example computing device that may be arranged for task scheduling implementations, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn, inter alia, to methods and systems related to computer systems such as data storage centers and methods for efficiently operating such computer systems to reduce the cost of the electrical energy consumed in the operation. An example embodiment generally relates to selecting times at which some tasks are performed. For example, certain tasks may be performed at times at which the cost of electrical energy is relatively low, or at times at which the need for air conditioning and/or circulating liquid to cool the electronics of the computer system is relatively low.

Data storage centers often have tasks that may need to run constantly, or at regular time intervals. However, data storage centers may also have tasks that may be performed with more flexible time schedules, or perhaps not at all if the cost of performing the task exceeds the benefit. Such elective tasks may need to run only once in a while, or at intermittent or irregular time intervals. Such elective tasks may include data backup, indexing, media encoding, and data mining. Inefficient batch computing of these tasks may result in significant additional financial cost.

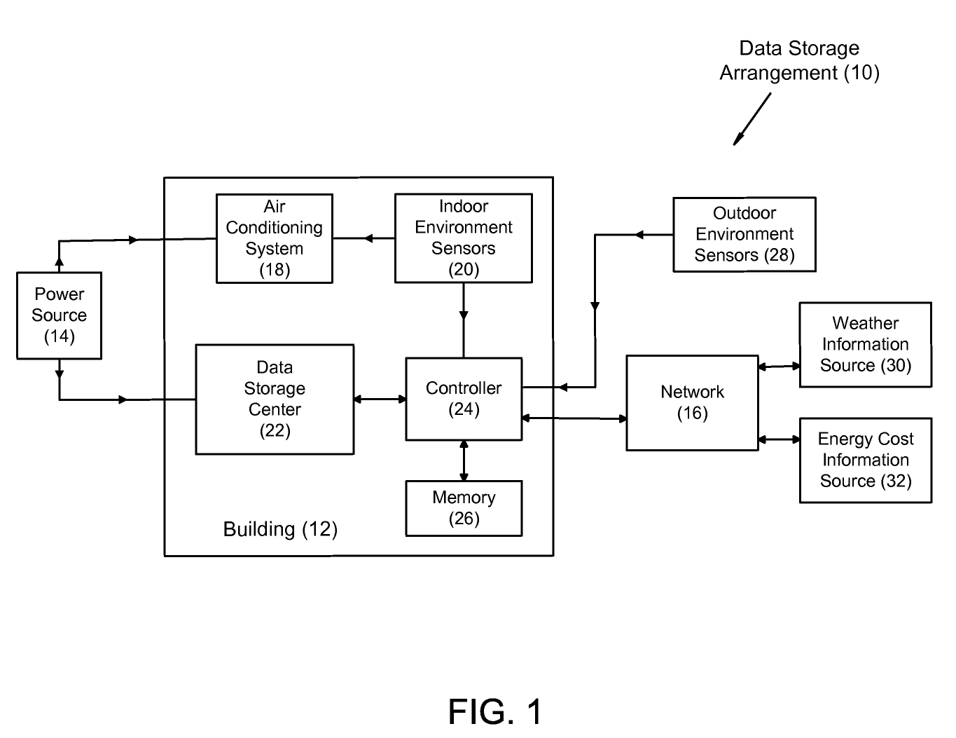

FIG. 1 is a block diagram of an example data storage arrangement 10 that is arranged in accordance with at least some embodiments of the present disclosure. The example data storage arrangement 10 includes a building 12 electrically and/or communicatively connected to utilities such as a power source 14 and a network 16. Power source 14 may be in the form of an electrical power grid or power lines provided by an electrical power company. Network 16 may be implemented as any network, such as the Internet, an Intranet, or a cellular network. In the case of the Internet being used as network 16, connection between building 12 and network 16 may be provided via an Internet Service Provider (ISP), for example.

Disposed within building 12 may be an air conditioning system 18, indoor environment sensors 20, and a computer system including a data storage system 22, an electrical controller 24 and a memory device 26. Power source 14 may provide electrical energy to air conditioning system 18 and to data storage center 22.

Power source 14 may also provide electrical energy to indoor environment sensors 20 and other components of the computer system such as controller 24 and memory 26. However, the electrical energy consumed by sensors 20, controller 24 and memory 26 may be negligible as compared to the electrical energy consumed by air conditioning system 18 and data storage center 22.

Indoor environment sensors 20 may include a thermometer, e.g., temperature sensor, and possibly a humidity sensor, both of which may be disposed in close proximity to data storage center 22. The thermometer and possibly the humidity sensor may be included in a thermostat (not shown) which may control the operation of air conditioning system 18, such as by applying operating voltage to air conditioning system 18 or by removing the operating voltage therefrom.

Data storage center 22 may perform some tasks continuously or at regular time intervals. Other tasks (“elective tasks”) performed by data storage center 22 may be performed intermittently, or at irregular time intervals. In addition to the already-mentioned elective tasks of backing up data, indexing data, media encoding, and mining data, the elective tasks may include data management, transaction processing, computer modeling/simulation, process modeling, scientific computing, video imaging, and web crawling. Data management may include data migration to other data centers, data archiving, and virus scanning. Transaction processing may include payroll processing, invoicing, enterprise resource planning (ERP), customer relationship management (CRM), and bank transaction processing performed at the end of the day. Computer modeling/simulation may include weather prediction, register transfer level (RTL) simulation, spice/analog circuit simulation, electronics fields analysis, thermal analysis, mechanical stress analysis, seismic analysis, oil field extraction optimization, computational chemistry, and biomechanical modeling. Process modeling may include modeling of chemistry processes and semiconductor fabrication. Video imaging may include rendering an image and formal conversion.

Data storage center 22 may include various different architectures, but may include components related to infrastructure or the operating environment; telecommunications components; networking; storage systems and backup storage systems; servers, which may be mounted in racks; and/or storage networking components. Components related to infrastructure or the operating environment may include power components, uninterruptible power supplies (UPS), cooling components, and fire suppression components. Infrastructure components may be in the form of support equipment that makes the operation of the data center possible or more reliable. For example the UPS is not required, but increases the reliability of the data center.

Components of data storage center 22 related to telecommunications may include firewalls and network connection components such as modems. Components related to networking may include routers, switches, concentrators, and bridges. Of course, some of these components may be optional such as the UPS, fire suppression components, and storage network components. The normal data network may also be used for the storage of data. Some telecommunications components may enable access to the internet or to other data center sites, and thus may provide a network connection between the data center and the rest of the world.

There may be networks internal to the data center that may be used to connect all of the different servers together. The data network may also be used to connect the servers to the storage, or there may be a separate storage network such as a fiber channel network. The network may include different components depending on the complexity of the data center. The network may include concentrators that may connect multiple servers together and then connect them to a router. The exact configuration of the network and network components may be dependent on the data center.

Data storage center 22 may also use redundancy to improve the reliability of the operations. For example, each server may be connected to two different networks. It may also be possible that any function in the data center can be performed by more than one piece of equipment.

Controller 24 may be in the form of a computer server. Some form of redundancy may be employed to improve the availability of the system. For example, the control application may run on two different servers.

In one embodiment, controller 24 may select times at which those elective tasks that may be performed intermittently, or at irregular time intervals, are actually performed. The present disclosure considers that controller 24 may select times at which these elective tasks may be performed to thereby reduce the cost of the electrical energy consumed in performing the elective tasks.

The present disclosure also considers that the cost of the electrical energy consumed in performing the elective tasks may be a function of at least two factors. The first factor may be the price charged by the electrical utility company per unit of electrical energy at the particular time at which the task is performed. For instance, the electrical utility company may charge less per unit of electrical energy at 2 a.m. when demand for electricity may be relatively low than at 2 p.m. when demand for electricity may be relatively high. The price per unit of electrical energy may also vary with the day of the week and/or the month. For example, the price of a unit of electrical energy may be greater in the hot summer months, when the demand for electrically-powered air conditioning may be high, than in the cold winter months, when demand for electrical power may be less due to buildings often being climate controlled via natural gas rather than via electricity.

The second factor in the cost of the electrical energy consumed in performing the elective tasks may be the incremental amount of electrical energy that is consumed as a result of the elective task being performed. For example, there may be an incremental amount of electrical energy consumed by the elective task being performed, and there may be an additional incremental increase in electrical energy consumed due to air conditioning that may be produced as a result of the elective task being performed. In a scenario in which the air conditioning is already running at, or near, full capacity, the performance of an elective task may result in a relatively great increase in energy expended on additional air conditioning.

In scenarios in which the air conditioning system is not always capable of maintaining the operating temperature of the data storage center within a tight band, the performance of an elective task by the data storage center may also raise the operating temperature of the data storage center to a point where the data storage center consumes greater amounts of energy in performing regularly-scheduled tasks as well as in performing additional elective tasks. That is, the increase in operating temperature that results from performing an elective task may result in a decrease in operating efficiency of the data storage center, thereby causing the data storage center to consume greater amounts of energy in performing regularly-scheduled tasks and in performing any other elective tasks.

Increased humidity levels within building 12 and/or within data storage center 22 may increase the electrical energy consumed in cooling data storage center 22. Thus, an estimation of a rate at which electrical energy would be consumed by the performance of an elective task may be based, at least in part, on a current temperature within data storage center 22 and a current humidity level within data storage center 22.

Conversely, when the outside temperature is low, air conditioning system 18 may not need to run at full capacity, or may not need to run at all, in order for data storage center 22 to remain under a threshold temperature. In this scenario, the performance of an elective task may result in relatively little additional air conditioning, or none at all. Thus, in cooler weather, elective tasks may be run economically since the performance of the elective task may result in little or no electrical energy being expended on additional air conditioning.

Other weather conditions in addition to temperature may affect the amount of electrical energy consumed by air conditioning. For example, high wind speed and rain may serve to cool the outdoor condenser (not shown) of air conditioning system 10, thereby enabling air conditioning system 10 to operate more efficiently and hence inexpensively. The amount of sunshine versus cloud cover may also affect the amount of air conditioning that is consumed in cooling data storage center 22. Fox example, high levels of sunshine may result in building 12 heating up beyond what may be indicated by the outside temperature alone. Along these lines, the time-of-day and the time-of-year may indicate the angle of the sun in the sky and hence the amount of the sun's radiation that reaches building 12 as well as the amount of atmosphere that the radiation passes through before reaching building 12. Thus, the time-of-day and the time-of-year (the month, for example) may also affect the amount of electrical energy consumed by additional air conditioning as a result of the performance of an elective task. For at least these reasons, controller 24 may take into account the effects of the time-of-day and the time-of-year on the cost of electrical energy in deciding when an elective task is to be performed.

In order to gather information on the basis of which to decide when to cause the elective tasks to be performed, controller 24 may be communicatively coupled to external sources of information. More particularly, in the embodiment shown in FIG. 1, controller 24 may be communicatively coupled to outdoor environment sensors 28, a source of weather information 30, and a source of electrical energy cost information 32. Outdoor environment sensors 28 may include a thermometer, a humidity sensor, a precipitation sensor, a wind sensor, and/or a solar sensor, for example. Outdoor environment sensors 28 may be disposed at the location of data storage center 22. For example, outdoor environment sensors 28 may be disposed on or adjacent to building 12.

Controller 24 may be communicatively coupled to weather information source 30 and energy cost information source 32 via network 16. Weather information source 30 may be a weather information database or a web site operated by the national weather service or by a local television station, for example. The weather information that is provided may include current weather conditions as well as predicted weather conditions. The time horizon of the predicted weather conditions may approximately match the latest time and day that controller 24 may consider for the performance of an elective task. The current and/or predicted weather conditions provided by weather information source 30 may include temperature, humidity, precipitation, wind speed and direction, and percent of possible sunshine, for example.

Energy cost information source 32 may be an energy cost information database or a web site operated by the electric utility company that provides and/or operates power source 14, for example. It is also possible for the web site to be operated by a third party. The instantaneous energy cost information that is provided may include the current price charged by the utility company for electrical energy, which may be expressed in kilowatt-hours. The instantaneous energy cost information may also include historical and/or predicted prices charged for electrical energy, for example.

Controller 24 may use the historical prices charged for electrical energy to predict future prices charged for electrical energy, particularly if predicted prices are not provided by energy cost information source 32. For example, the historical data may be used to identify patterns in the times and/or days at which low energy costs and high energy cost occur. These patterns may then be extrapolated into the future to predict future energy costs, and particularly times at which costs are high or low. Alternatively, or in addition, controller 24 may store energy cost information in memory device 26. Controller 24 may then use the stored energy cost information in memory device 26 as historical information in predicting future prices charged for electrical energy.

As an example, according to a prediction model based on historical energy cost data, at 1:00 pm the cost of electricity may be significantly higher than the cost of electricity at 1:00 am. Therefore, the automated process run by controller 24 may decide that the elective task or “batch job” should not be performed until 1:00 am.

As another example, perhaps in conjunction with the historical data, there may be predetermined criteria that may define a threshold cost for electricity that is suitable/tolerable for performing elective tasks. For example, if the criteria indicate that $0.08 per kilowatt-hour (kWH) is a tolerable threshold cost for electricity, then once the cost of electricity drops to $0.08 per kWH or less, the automated process run by controller 24 may allow the elective task or “batch job” to be performed.

Similarly, in a situation where an elective task has already been started and is currently processing, if the price of electricity suddenly rises, the elective task may be suspended or terminated until some time in the future, such as when the electricity costs drop back down to a suitable level. However, the automated process may also use data relating to the criticality of an elective task (e.g., the length of time since the last backup) and may ignore the financial impact if an elective task is deemed to be too critical to put off to a later time. As described above, the performance of an elective task may be commenced, resumed, continued, inhibited, and/or ceased based, at least in part, on a comparison of an ascertained electrical energy cost to a threshold electrical energy cost.

It is possible that multiple power sources 14 may be available, each having its own schedule of energy costs as a function of time. In this case, controller 24 may additionally choose which power source 14 is to provide the energy for performing the elective task. In one example, controller 24 may make this choice of power source on the basis of cost reduction or cost minimization of the elective task.

During operation, controller 24 may determine that data storage center 22 has an elective task that may be performed at a selected time in the near future. The elective task may be a maintenance procedure and/or a procedure that is to be performed at semi-regular time intervals wherein there is some leeway or discretion as to the exact time at which the elective task is performed. Controller 24 may select a time at which the cost of performing the elective task is relatively low. In order to identify a time at which the cost of performing the elective task is relatively low, controller 24 may receive inputs from indoor environment sensors 20, outdoor environment sensors 28, weather information source 30 and/or energy cost information source 32. Controller 24 may use algorithms, formulae, graphs, and/or lookup tables that relate the data from indoor environment sensors 20, outdoor environment sensors 28, and/or weather information source 30 to an amount of electrical energy that may be consumed in performing the elective task. By multiplying the expected electrical energy consumed in performing an elective task by the cost per unit energy as provided by energy cost information source 32, controller 24 may determine the cost of performing the elective task at a given time. By comparing the costs of performing the elective task at different times, controller 24 may determine a most inexpensive, or at least a relatively inexpensive, time at which the elective task is to be performed.

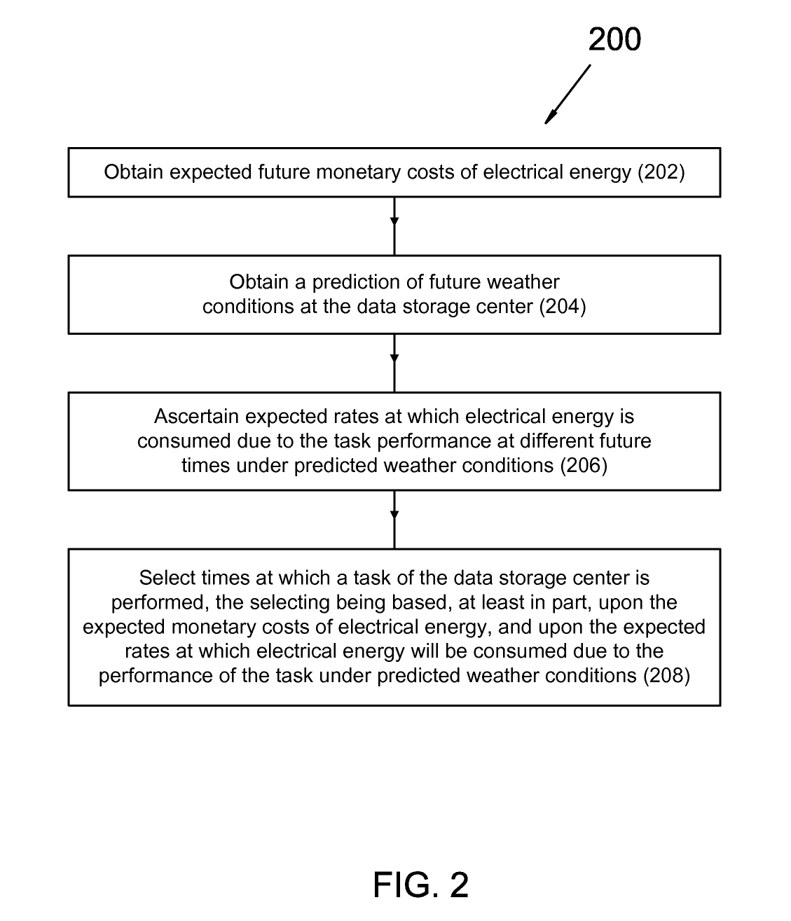

FIG. 2 is a flowchart showing the operation of an example task scheduling method 200 for a data storage center, as contemplated by at least some embodiments of the present disclosure. The example embodiments may include one or more of processing operations 202, 204, 206 and 208. Processing begins at operation 202, where expected future monetary costs of electrical energy are obtained. In one embodiment, expected future monetary costs of electrical energy are obtained from an energy cost information source 32, which may be an energy cost information database or a web site operated by the electric utility company that provides and/or operates power source 14, for example. The expected future energy cost information that is obtained may include the expected future price to be charged by the utility company for electrical energy. It is also possible for the expected future monetary costs to be obtained from predictions based upon historical prices charged for electrical energy.

Processing flows from operation 202 to operation 204. Operation 204 may include obtaining a prediction of future weather conditions at the data storage center. The prediction of future weather conditions may be obtained from a weather information source 30 which may be in the form of a weather information database or a web site operated by the national weather service or by a local television station, for example. The predicted weather conditions may be for the time period from the present time until the most distant future time and day that controller 24 may consider for the performance of an elective task. The predicted weather conditions provided by weather information source 30 may include temperature, humidity, precipitation, wind speed and direction, and percent of possible sunshine, for example.

In a next operation 206, expected rates are ascertained at which electrical energy is consumed due to the task performance at different future times under predicted weather conditions. For example, based on empirical data, formulae and/or lookup tables may be devised that relate the rate of electrical energy consumption during a task to various weather conditions at the time the task is performed. In one embodiment, regression analysis may be used to establish mathematical relationships between the rates of electrical energy consumption and the prevailing weather conditions at the time of task performance.

In operation 208, times are selected at which a task of the data storage center is performed. The selecting may be based, at least in part, upon the expected monetary costs of electrical energy, and upon the expected rates at which electrical energy will be consumed due to the performance of the task under predicted weather conditions. For example, for each of a plurality of candidate task-performance times, or time periods, the expected monetary cost of electrical energy may be multiplied by the expected rate at which electrical energy will be consumed due to the performance of the task. As a result, the expected costs of electrical energy to perform the task at each of the candidate times may be thereby calculated. The time with the lowest resulting expected cost of electrical energy to perform the task may be selected as the actual time at which the task will be performed.

In an example embodiment, a data storage arrangement 10 may be configured to implement the method of FIG. 2.

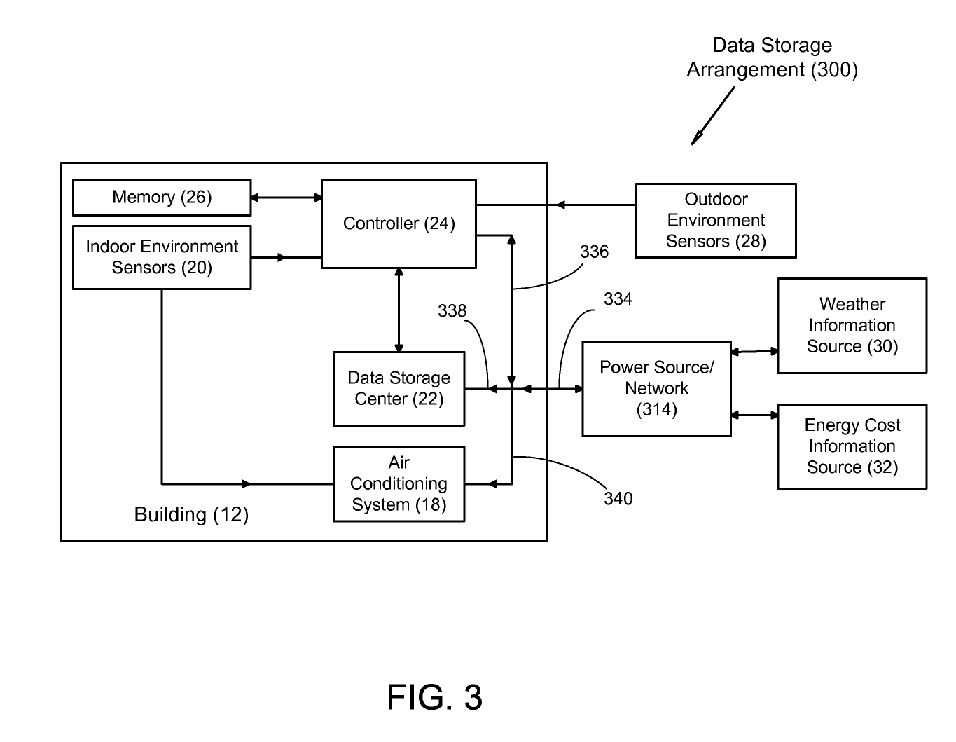

FIG. 3 is a block diagram of an example data storage arrangement 300 that is arranged in accordance with at least some additional embodiments of the present disclosure. The example data storage arrangement 300 includes a building 12 electrically and/or communicatively connected to a utility 314 that may operate as both a power source and a communication network. Utility 314 may include an electrical power grid or power lines provided by an electrical power company, wherein communication signals are also carried by the power grid or power lines.

Utility 314 may provide electrical energy to air conditioning system 18 and to data storage center 22, as well as lower levels of electrical energy to indoor environment sensors 20, controller 24 and memory 26. The electrical energy may be carried by the power grid or power lines of utility 314. The power grid or power lines of utility 314 may also communicatively couple controller 24 to source of weather information 30, and to source of electrical energy cost information 32.

In one embodiment, line 334 carries both information and power to and/or from utility 314. Within or near building 12, line 334 may branch out into a line 336 that may bi-directionally carry information between controller 24 and utility 314; a line 338 that carries power to data storage center 22; and a line 340 that caries power to air conditioning system 18. Other aspects of data storage arrangement 300 may be substantially similar to those of data storage arrangement 10, and thus are not described herein in order to avoid needless repetition.

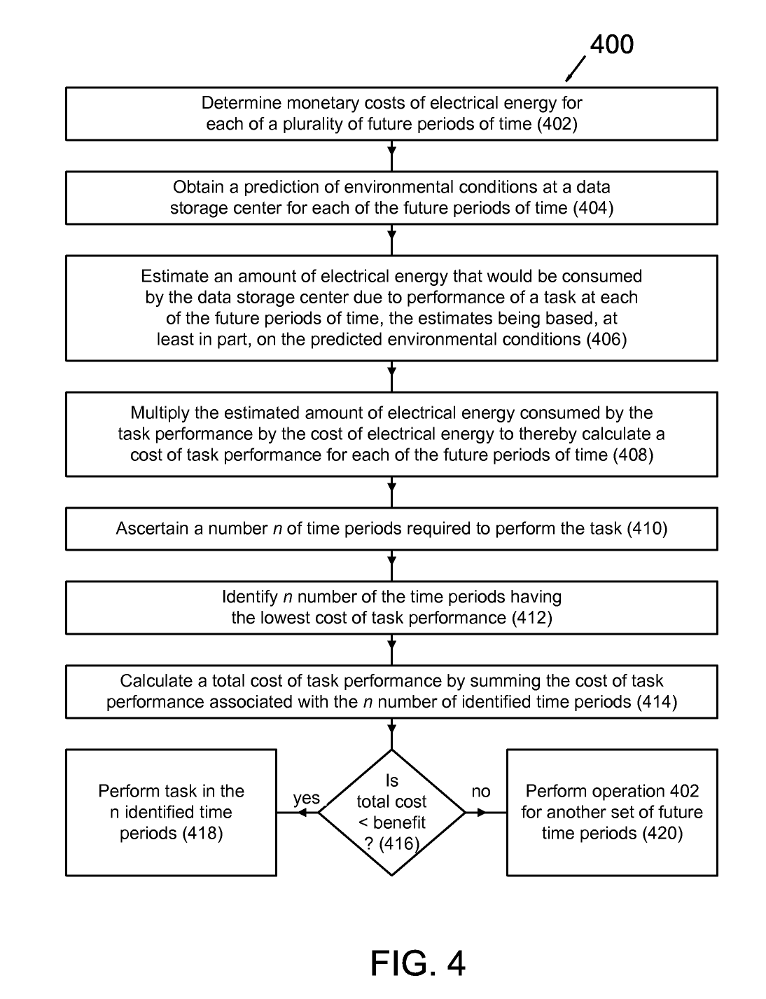

FIG. 4 is a flowchart showing the operation of another example task scheduling method 400 for a data storage center, as contemplated by at least some embodiments of the present disclosure. The example embodiments may include one or more of processing operations 402, 404, 406, 408, 410, 412, 414, 416, 418 and 420. Processing begins at operation 402, where monetary costs of electrical energy for each of a group of future time periods are determined. In one embodiment, expected future monetary costs of electrical energy are obtained from an energy cost information source 32, which may be an energy cost information database or a web site operated by utility 314, for example. The expected future energy cost information that is obtained may include the expected future price to be charged by the utility company for electrical energy. It is also possible for the expected future monetary costs to be obtained from predictions based upon historical prices charged for electrical energy.

Processing flows from operation 402 to operation 404. Operation 404 may include obtaining a prediction of environmental conditions at the data storage center for each of the future time periods. The prediction of future environmental conditions may be obtained from a weather information source 30 which may be in the form of a weather information database or a web site operated by the national weather service or by a local television station, for example. The predicted weather conditions provided by weather information source 30 may include temperature, humidity, precipitation, wind speed and direction, and percent of possible sunshine, for example. The predicted environmental conditions may also or alternatively encompass the environmental conditions within building 12. For example, it may be known that building 12 will be unoccupied by people during certain ones of the future time periods. The owner of building 12 may be less inclined to operate air conditioning system 18 when there is no need to keep the environmental conditions within a range that is comfortable for humans. Thus, it may be predicted that the indoor environmental conditions will include relatively high levels of temperature and possibly humidity during the future time periods in which building 12 will be unoccupied by humans. On the other hand, with cold outdoor temperatures, it may be known that the temperature inside building 12 will be allowed to drop to below normal levels during time periods in which building 12 is planned to be unoccupied.

In a next operation 406, amounts of electrical energy that would be consumed by the data storage center due to the task performance at each of the future periods of time may be estimated. The estimates may be based, at least in part, on the predicted environmental conditions. For example, based on empirical data, formulae and/or lookup tables may be devised that relate the amount of electrical energy that is consumed due to performance of a task to various predicted environmental conditions at the time the task is performed. In one embodiment, regression analysis may be used to establish mathematical relationships between the amounts of electrical energy consumption and the prevailing environmental conditions at the time of task performance.

In operation 408, the estimated amount of electrical energy consumed due to the task performance is multiplied by the monetary cost of electrical energy to thereby calculate a cost of task performance for each of the future periods of time. If the task requires multiple periods of time to perform, then each of these periodic costs of task performance may represent only a portion of the total cost of the performance of the task.

In operation 410, a number n of time periods required to perform the task is ascertained. For example, if a task is known to take three hours to perform, and each of the time periods is an hour long, then it may be ascertained that three of the time periods may be required to perform the task.

In a next operation 412, n number of time periods having the lowest cost of task performance are identified. Continuing the example above, among twenty-four consecutive one-hour periods, the three time periods of 2-3 am, 3-4 am and 5-6 am may be identified as having the lowest cost of task performance. This example assumes that it is possible to interrupt the task during the time period of 4-5 am. If, however, the nature of the task is such that performing it in three consecutive one-hour time periods is called for, then operation 412 may include identifying three consecutive one-hour time periods, such as 2-3 am, 3-4 am and 4-5 am, that have the lowest total cost.

Next, in operation 414, a total cost of task performance may be calculated by summing the cost of task performance associated with the n number of identified time periods. In the above example, if the task may be interrupted, then the task performance costs at 2-3 am, 3-4 am and 5-6 am may be summed to thereby calculate a total cost of task performance. If, however, uninterrupted task performance is called for, then the total cost of task performance may already have been calculated as described above with reference to operation 412.

In operation 416, it is determined whether the total cost of task performance calculated in operation 414 is less than the economic benefit expected to be derived from the performance of the task. The economic benefit may vary, for example, with the length of time since the task was last performed. An algorithm or lookup table may be provided that specifies the economic benefit of the task, perhaps as a function of one or more variables. In another embodiment, the lookup table may simply specify a maximum cost under which the task should be performed.

If it is determined in operation 416 that the total cost of performing the task is less than the expected benefit, then the task may be performed in the n identified time periods (operation 418). However, if it is determined in operation 416 that the total cost of performing the task is not less than the expected benefit, then the process may return to operation 402 where energy costs are determined for another, possibly later, set of future time periods. This next set of time future periods may partially overlap the immediately previous set of future time periods. The process may continue on from operation 402 substantially as described above.

In an example embodiment, either of data storage arrangements 10 and 300 may be configured to implement the method of FIG. 4.

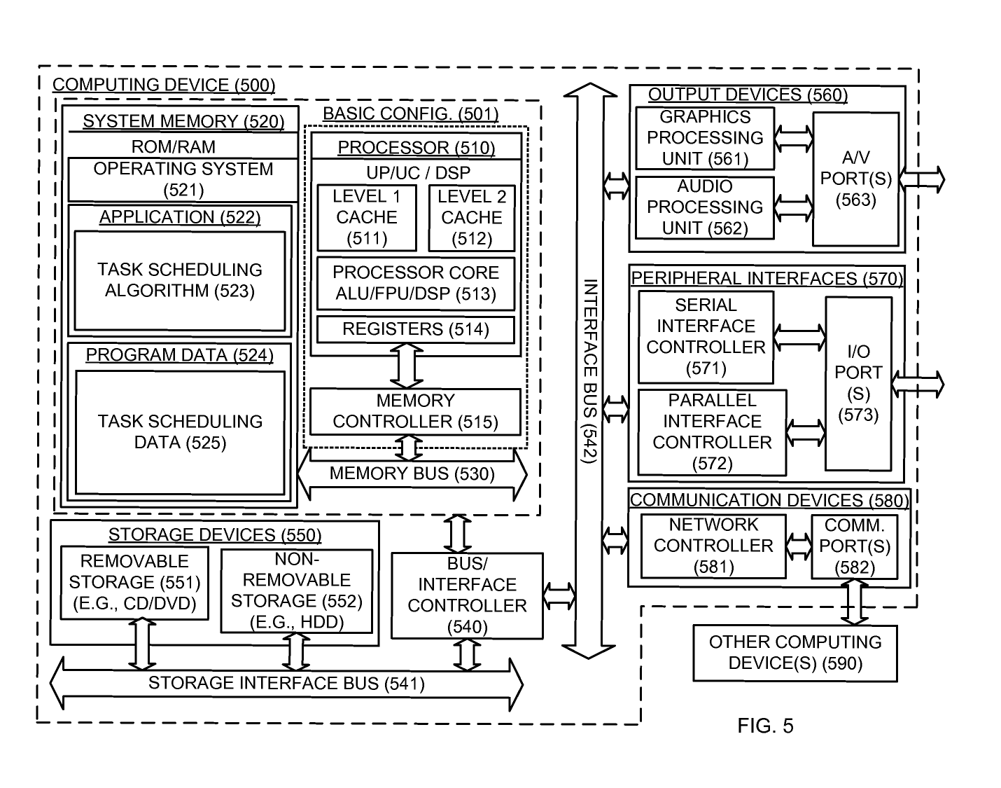

With reference to FIG. 5, depicted is a block diagram illustrating an example computing device 500 that is arranged for data storage implementations in accordance with at least some embodiments of the present disclosure. In a very basic configuration 501, computing device 500 typically includes one or more processors 510 and system memory 520. A memory bus 530 may be used for communicating between the processor 310 and the system memory 320.

Depending on the desired configuration, processor 510 may be of any type including but not limited to a microprocessor (μP), a microcontroller (μC), a digital signal processor (DSP), or any combination thereof. Processor 510 may include one more levels of caching, such as a level one cache 511 and a level two cache 512, a processor core 513, and registers 514. The processor core 513 may include an arithmetic logic unit (ALU), a floating point unit (FPU), a digital signal processing core (DSP Core), or any combination thereof. A memory controller 515 may also be used with the processor 510, or in some implementations the memory controller 515 may be an internal part of the processor 510.

Depending on the desired configuration, the system memory 520 may be of any type including but not limited to volatile memory (such as RAM), non-volatile memory (such as ROM, flash memory, etc.) or any combination thereof. System memory 520 may include an operating system 521, one or more applications 522, and program data 524. Application 522 may include a task scheduling algorithm 523 that is implemented to efficiently schedule the performance of elective tasks by data storage center 22. Program Data 524 may include task scheduling data 525. In some embodiments, application 522 may be arranged to operate with program data 524 on an operating system 521 to effectuate the scheduling of the performance of elective tasks by data storage center 22. This described basic configuration is illustrated in FIG. 5 by those components within dashed line 501.

Computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The data storage devices 550 may be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of device 500.

Computing device 500 may also include an interface bus 542 for facilitating communication from various interface devices (e.g., output interfaces, peripheral interfaces, and communication interfaces) to the basic configuration 501 via the bus/interface controller 540. Example output devices 560 include a graphics processing unit 561 and an audio processing unit 562, which may be configured to communicate to various external devices such as a display or speakers via one or more A/V ports 563. Example peripheral interfaces 570 include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication device 580 includes a network controller 581, which may be arranged to facilitate communications with one or more other computing devices 590 over a network communication via one or more communication ports 582. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

According to one embodiment, computing device 500 is connected in a networking environment such that the processor 510, application 522 and/or program data 524 may perform with or as a computer system in accordance with embodiments herein.

The present disclosure may contemplate selecting a time at which a data storage center is to perform an elective task such that the cost of electricity is reduced. However, the present disclosure also contemplates controlling other parameters of the performance of an elective task such that the cost of electricity is reduced, and this control may also be based upon the cost of electrical energy and how the parameters affect the consumption of electrical energy. Such controlled parameters of the performance of an elective task may include the speed of performance; the priority of the performance of the elective task relative to that of other tasks; the frequency of performance; the level of performance; and the percentage of available computing capacity utilized in the performance.

The present disclosure may contemplate selecting a time of elective task performance based, at least in part, upon changing costs of electrical energy as dynamically provided by a power utility company. However, in another embodiment, current and future costs of electrical energy are specified by a legal contract between the owner of the data storage center and the power utility company. Such contracted electrical energy costs may vary with time and may be stored in a memory device associated with the controller of the data storage center. The controller may then base its decision on when to perform an elective task, at least in part, on the contractually-determined electrical energy costs.

The present disclosure may contemplate using air conditioning to cool a data storage center and its environment. However, in another embodiment, a data storage center may be cooled with a liquid, such as water. Water cooling may involve electricity use analogous to that of air conditioning. Further, the amounts of electricity used in liquid cooling may vary with weather conditions as well as with the other factors described above in association with air conditioning.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A task scheduling method, the method comprising:
operating a data storage center that is coupled to at least a power supply component, a networking component, and a data storage component; and
controlling times at which a task of the data storage center is performed, the controlling being based, at least in part, upon:
expected future monetary costs of electrical energy; and
expected rates at which electrical energy is consumed due to the performance of the task at different future times.

2. The method of claim 1, wherein the task includes:
backing up data;
indexing data;
media encoding; and/or
mining data.

3. The method of claim 1, further comprising obtaining a prediction of weather conditions associated with the data storage center at the different future times, wherein the expected rates at which electrical energy is consumed due to the performance of the task are based, at least in part, on the prediction of weather conditions.

4. The method of claim 3, wherein the prediction of weather conditions is obtained from a web service, a weather information database, or weather data measured at the data storage center.

5. The method of claim 1, wherein the expected rates at which electrical energy is consumed due to the performance of the task are based, at least in part, on a time-of-year and time-of-day at which the task is performed.

6. The method of claim 1, wherein whether the task is performed at a certain time depends, at least in part, on whether the expected monetary cost of electrical energy at the certain time exceeds a threshold cost.

7. The method of claim 1, wherein the expected monetary costs of electrical energy includes instantaneous information from a web service.

8. The method of claim 1, wherein the expected monetary costs of electrical energy is obtained from a web-based interface of a power utility company.

9. The method of claim 1, further comprising entering into a contract with an energy utility company, the contract specifying the monetary costs of electrical energy at future times.

10. A data storage arrangement, comprising:
a data storage center configured to perform a task, wherein the data storage center is coupled to at least a power supply component, a networking component, and a data storage component; and
a controller coupled to the data storage center and configured to:
determine expected future monetary costs of electrical energy;
obtain a prediction of weather conditions at the data storage center at different future times;
estimate rates at which electrical energy would be consumed due to the performance of the task at the different future times, the estimating being based, at least in part, on the predicted weather conditions;
ascertain electrical energy costs of the task performance at the different future times, the ascertaining being based on the expected future monetary costs of electrical energy and the estimated rates at which electrical energy would be consumed due to the performance of the task at the different future times; and
select a time at which the data storage center performs the task, the time being selected based, at least in part, on the electrical energy costs of the task performance at the different future times.

11. The arrangement of claim 10, wherein the prediction of weather conditions is obtained from a web service, a weather information database, or weather data collected at the data storage center.

12. The arrangement of claim 10, wherein the estimated rates are based, at least in part, on a date and/or a time-of-day of the different future times.

13. The arrangement of claim 10, wherein the controller is configured to determine the expected future monetary costs of electrical energy based, at least in part, on historical cost data.

14. A data storage arrangement, comprising:
a data storage center configured to perform a task, wherein the data storage center is coupled to at least a power supply component, a networking component, and a data storage component; and
a controller coupled to the data storage center and configured to:
receive updates of monetary costs of electrical energy, each of the updates being associated with a respective period of time;
receive updates regarding weather conditions at the data storage center during the periods of time; and
for each current said period of time:
estimate a rate at which electrical energy would be consumed due to the performance of the task during the current period of time, the estimating being based, at least in part, on current said monitored weather conditions;
ascertain an electrical energy cost of the task performance during the current period of time, the ascertaining being based, at least in part, on the received monetary costs of electrical energy associated with the current period of time and on the estimated rate at which electrical energy would be consumed due to the performance of the task during the current period of time;
compare the ascertained electrical energy cost of the task performance to a threshold electrical energy cost; and
based on the comparison of the ascertained electrical energy cost to the threshold electrical energy cost, either:
commence the task performance;
resume the task performance;
continue the task performance;
inhibit commencement of the task performance; or
cease the task performance.

15. The arrangement of claim 14, wherein the estimating is based, at least in part, on a current temperature within the data storage center and a current humidity level within the data storage center.

16. The arrangement of claim 14, wherein the task includes:
backing up data;
indexing data;
media encoding; and/or
mining data.

17. The arrangement of claim 14, wherein the controller is communicatively coupled to the Internet, the controller being configured to obtain the weather conditions from a first web service.

18. The arrangement of claim 17, wherein the updates of monetary costs of electrical energy are received from a second web service.

19. The arrangement of claim 17, wherein the updates of monetary costs of electrical energy are received from a web-based interface of a power utility company.

20. The arrangement of claim 17, wherein the controller is configured to determine the updates of monetary costs of electrical energy based, at least in part, on historical cost data.

21. A computer memory device including instructions for controlling operation of a computerized controller coupled to a data storage center, wherein the instructions are configured to cause the computerized controller to perform at least the operations of:
determine monetary costs of electrical energy, each of the costs of electrical energy being associated with a respective one of a plurality of periods of time;
obtain predictions of environmental conditions at the data storage center, each of the predictions being associated with a respective one of the periods of time;
estimate rates at which electrical energy would be consumed due to performance of a task by the data storage center, each of the rates being associated with a respective one of the periods of time, the estimating being based, at least in part, on the predicted environmental conditions;
ascertain electrical energy costs of the task performance, each of the costs of task performance being associated with a respective one of the periods of time, the ascertaining being based, at least in part, on the costs of electrical energy and on the estimated rates at which electrical energy would be consumed due to the task performance; and
based on the ascertained electrical energy cost in each of the periods of time, decide that the task should be performed in:
none of the periods of time,
one of the periods of time; or
a plurality of the periods of time.

22. The device of claim 21, wherein the environmental conditions include outdoor weather conditions and/or a temperature associated with the data storage center.

23. The device of claim 21, wherein the task includes:
backing up data;
indexing data;
media encoding; and/or
mining data.

24. The device of claim 21, wherein the predictions are obtained, at least partially, from a first web service.

25. The device of claim 24, wherein the monetary costs of electrical energy are received from a second web service.

26. The device of claim 21, wherein the instructions are configured to cause the computerized controller to retrieve historical electrical energy cost data from a memory device, the monetary costs of electrical energy being determined based, at least in part, on the historical electrical energy cost data.
